(19) United States
(12) Patent Application Publication
(10) Pub. No.: US 2022/0180013 A1
(43) Pub. Date: Jun. 9, 2022

(54) VOLUME SEPARATION IN CAD MODELS

(71) Applicant: Siemens Industry Software Inc., Plano, TX (US)

(72) Inventor: David McLaurin, Leander, TX (US)

(21) Appl. No.: 17/437,305

(22) PCT Filed: Mar. 15, 2019
(86) PCT No.: PCT/US2019/022483

§ 371 Date: Sep. 8, 2021

(51) Int. Cl. G06F 30/10

(52) U.S. Cl. CPC G06F 30/10; G06F 2119/18

(57) ABSTRACT

Methods for CAD operations and corresponding systems and computer-readable mediums are disclosed herein. A method can be performed by a data processing system and includes receiving a model of a part to be manufactured, wherein the model includes a first partial volume connected via a gap to a second partial volume. The method includes receiving a wall-distance value and applying the wall-distance value to the first partial volume of the model to define an initial volume having initial-volume boundaries. The method includes refining the initial-volume boundaries, generating at least one new surface in the model, and storing a modified model of the part to be manufactured, including the new surface.

### TECHNICAL FIELD

The present disclosure is directed, in general, to computer-aided design, engineering, visualization, and manufacturing systems (“CAD systems”), product lifecycle management (“PLM”) systems, and similar systems, that manage data for products and other items (collectively, “Product Data Management” systems or PDM systems).

### BACKGROUND OF THE DISCLOSURE

CAD systems are useful for designing and visualizing two-dimensional (2D) and three-dimensional (3D) models and drawings for manufacture as physical products. Improved systems are desirable.

### SUMMARY OF THE DISCLOSURE

Various disclosed embodiments include a method for CAD operations and corresponding systems and computer-readable mediums are disclosed herein. A method includes receiving a model of a part to be manufactured by a data processing system, wherein the model includes a first partial volume connected via a gap to a second partial volume. The method includes receiving a wall-distance value by the data processing system. The method includes applying, by the data processing system, the wall-distance value to the first partial volume of the model to define an initial volume having initial-volume boundaries. The method includes refining the initial-volume boundaries by the data processing system. The method includes generating at least one new surface in the model by the data processing system. The method includes storing a modified model of the part to be manufactured by the data processing system, including the new surface.

Various disclosed embodiments also include a data processing system including a processor. The data processing system also includes an accessible memory. The data processing system is particularly configured to perform processes as described herein.

Various disclosed embodiments further include a non-transitory computer-readable medium encoded with executable instructions that, when executed, cause one or more data processing systems to perform processes as described herein.

In some embodiments, refining the initial-volume boundaries is performed using a gradient-descent method. In some embodiments, refining the initial-volume boundaries includes moving the initial volume boundaries in a direction that is normal to a surface of the initial volume boundaries at each of a plurality of points on the surface. In some embodiments, refining the initial-volume boundaries includes moving the initial volume boundaries in a direction that is normal to a surface of the initial volume boundaries at each of a plurality of points on the surface until the initial volume boundaries meet a wall of the first partial volume or until a gradient of a gradient-descent method reaches zero. In some embodiments, the first partial volume is a two-dimensional volume or a three-dimensional volume. In some embodiments, the new surface is created to separate the first partial volume from the gap. In some embodiments, the new surface is created to separate the first partial volume from the gap where a gradient of a gradient-descent method reaches zero. Some embodiments include manufacturing a product based at least in part on the modified model. In some embodiments, the first partial volume includes a pocket.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of a CAD model of at least a portion of a product to be manufactured, in accordance with disclosed embodiments;

FIG. 2 illustrates an example of a CAD model where the single enclosed volume has been separated into exemplary separate volumes in accordance with disclosed embodiments;

FIG. 3 illustrates a flowchart of a process 300 in accordance with disclosed embodiments;

FIG. 4 illustrates an example of initial volumes in a model in accordance with disclosed embodiments;

FIG. 5 illustrates an example of expanding initial volumes in a model in accordance with disclosed embodiments;

FIG. 6 illustrates an example of the result of expanding the initial volumes in a model in accordance with disclosed embodiments;

FIG. 7 illustrates example of the result of expanding the initial volumes in a model where there is a pocket, in accordance with disclosed embodiments;

FIG. 8 illustrates an example of a modified model in accordance with disclosed embodiments that includes new surfaces; and

FIG. 9 illustrates a block diagram of a data processing system in which an embodiment can be implemented.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

CAD systems are used to design, model, visualize, and eventually manufacture parts for manufacture, and various commercial CAD and computer aided engineering (CAE) software products are available. However, exchanging CAD model data between different systems can be problematic. For example, for complex parts like the ones used for automotive car-body panels or aerospace structures, the CAD model contains small faces and edges that arise from CAD feature operators or as artifacts of translation when a CAD part developed in one CAD software product is then brought into another CAD software product. In other cases, distinct volumetric areas (whether the “volume” represents an open-space volume or a solid volume) may be erroneously connected into a single volumetric area by an open “gap” or connecting solid portion, preventing the separate volumes from being accurately represented and manipulated in the CAD system.

Some systems use physics-based or volume mesh resolution approaches to attempt to separate volumes. The physics-based approach assumes that the user can indicate the volumes which are to be separated a priori. A heat equation is solved on a spatial partitioning data structure (usually an octree) to find areas of high flux. Those areas are presumably the places where the volumes “leak” into each other and a surface would be generated to separate physically the two (or more) volumes. This method requires user input to indicate the volumes to be separated, which prevents any effective automatic processing.

The volume-mesh resolution method resolves the volume at a particular size using a spatial partition data structure (usually an octree) and separates only those volumes which can be resolved by the data structure at the user-specified size. This method requires the volume to be resolved using a spatial data structure. The drawbacks to this approach include aliasing effects which affect the accuracy and reliability of the method. Additionally, the alignment of the surfaces with respect to the octants causes additional inaccuracy using this approach.

Disclosed embodiments include systems and methods for automatically separating connected volumes into distinct, independent volumes based on size information, providing computationally efficient, accurate, and automatic results. As used to describe the disclosed techniques herein, the “volume” refers to volumetric areas processed as described herein, whether representing an open-space volume or a solid volume, and “gap” refers to the connecting volume that connects two larger volumes.

A distance field calculation, as described below, can be used to define a separate volume within a partial volume. For a given volume inside of a geometric shape, each point in space is given a “wall-distance value” which is defined as the closest distance to the shape.

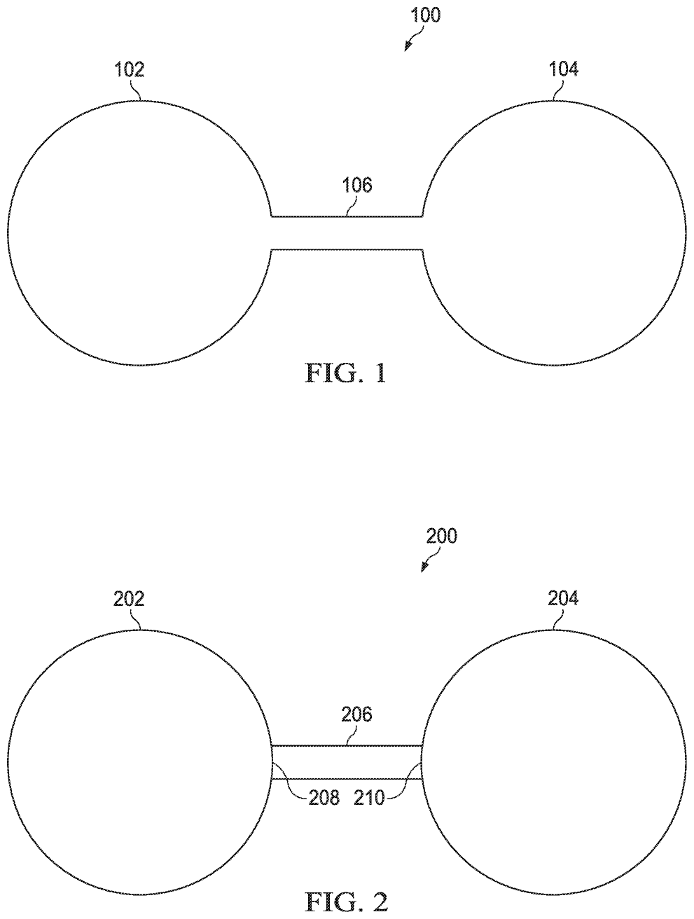

FIG. 1 illustrates an example of a CAD model 100, of at least a portion of a product to be manufactured, with a single enclosed volume. In this example, a first partial volume 102 and a second partial volume 104 are connected by a gap 106, so that they together form the single enclosed volume. While this example uses regularly-shaped “lobes” and a straight regular gap, those of skill in the art will understand that in practice, each of the volumes and gapes will typically be irregularly shaped, and the disclosed embodiments are not limited to any specific shapes or dimensions. For example, a given model to be processed may have two irregularly shaped, differently-sized volumes connected by a very-narrow gap of any shape, and in fact the gap may have a small enough width or other dimension that it is very difficult for a user to detect by visual inspection of the displayed model. Similarly, a model as processed herein will typically be part of a much larger assembly of the product to be manufactured, and the enclosed volume may represent two different solid elements incorrectly connected by the solid gap or may represent two open volumes enclosed by other parts of the assembly, incorrectly connected by an open gap. In either case, the boundaries/walls of the volume may be processed as described herein. The specific examples illustrated in the figures are in two dimensions, but the techniques disclosed herein also apply to 3D models and corresponding 3D operations.

In the example of FIG. 1, disclosed processes can automatically define a separate volume corresponding to first partial volume 102, apart from second partial volume 104 and gap 106. While the example described herein is specific to the process for first partial volume 102, similar processes could be performed to define a separate volume corresponding to second partial volume 104 or any number of volumes connected by gaps as described herein.

FIG. 2 illustrates an example of a CAD model 200, corresponding to CAD model 100, where the single enclosed volume has been separated into exemplary separate volumes 202 (by the addition of wall 208) and 204 (by the addition of wall 210), with gap 206 as a third volume. Note that the “wall,” as used herein, can refer to a simple 2D structure dividing the volumes, in 2D implementations, and can refer to a 3D structure dividing the volumes, in 3D implementations.

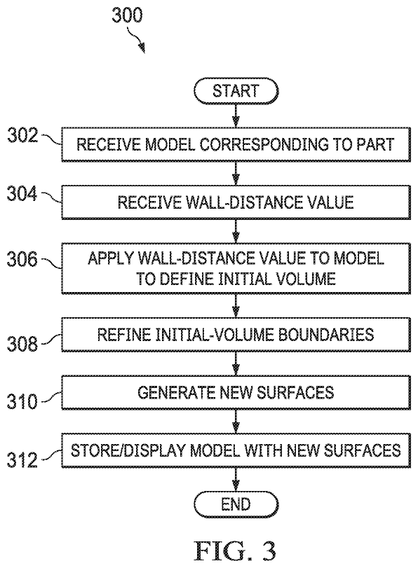

FIG. 3 illustrates a flowchart of a process 300 in accordance with disclosed embodiments that can be implemented by one or more data processing systems as described herein (referred to generically as the “system” below). Process 300 is described with references to non-limiting exemplary illustrations.

The system receives a model corresponding to a part to be manufactured (302). The model includes an enclosed volume, bounded by exterior walls, to be divided into multiple separate volumes, such as model 100. The model includes a gap that connects volumetric areas. “Receiving,” as used herein, can include loading from storage, receiving from another device or process, receiving via an interaction with a user, or otherwise.

The system receives a wall-distance value (304). In specific embodiments, the wall-distance value is specified by and received from a user. In specific cases, the wall-distance value is larger than a dimension of the gap. For example, in 2D cases, the wall-distance value can be larger than the width of the gap, or, in 3D cases, the wall-distance value can be larger than a diameter or largest 3D width of the gap. Note that in many implementations, where the presence of the gap is unknown (that is, since the volume has not yet been divided so the gap is not specifically identified), the wall-distance value can be defined as greater than the dimension of any possible gap that is intended to be removed.

The wall-distance value can be a user-defined size field which defines the size of gaps which should be closed at each point in space.

The system applies the wall-distance value to the model to define at least one initial volume (306). To do so, the system can define initial volume boundaries on the interior of the enclosed volume that are at the wall-distance value from the exterior boundaries of the enclosed volume. Where the wall-distance value is greater than the dimension of the gap, the gap itself may have no initial volume, but one or more other partial volumes may have an initial volume. This discussion is directed to any one of those initial volumes (the “first initial volume”) but can be applied to all or any of the initial volumes.

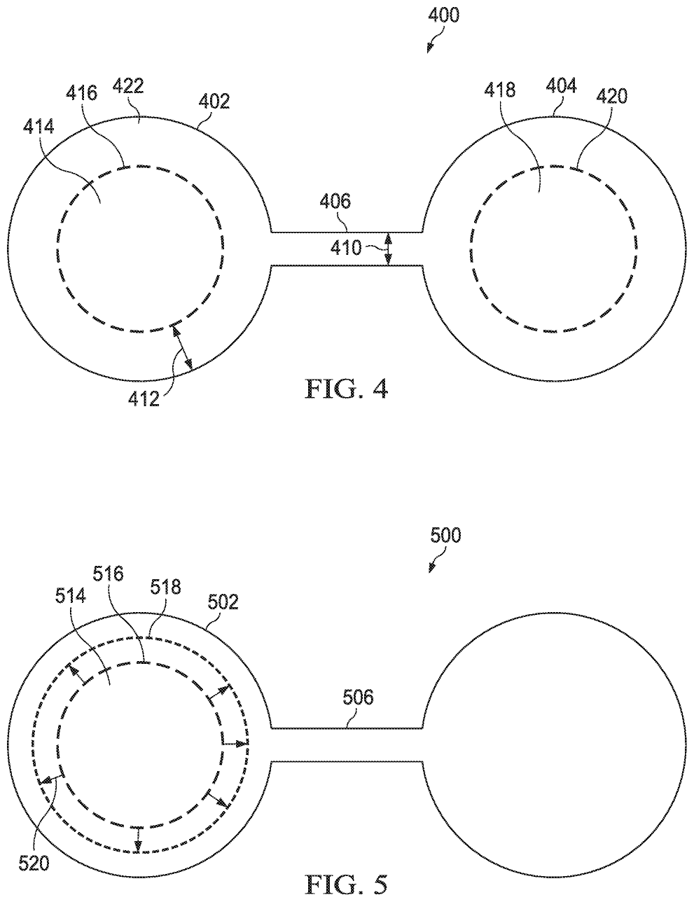

FIG. 4 illustrates an example of initial volumes in a model 400 in accordance with disclosed embodiments. In this example, a first partial volume 402 and a second partial volume 404 are connected by a gap 406, so that they together form the single enclosed volume. In this example, the gap dimension 410 is less than the wall-distance value 412. FIG. 4 illustrates an example of a first initial volume 414, with first initial volume boundaries 416 shown as a dotted line, and a second initial volume 418 with second initial volume boundaries 420 shown as a dotted line.

In 306, the system can separate points in space between those that are “near wall” and those that are “fluid”. “Near wall” refers to those points whose wall-distance is smaller than the wall-distance value or user-supplied size field at the same location, e.g., in area 422. “Fluid” designates those points whose wall-distance is larger than the wall-distance value or user-supplied size field at the same location. The initial volumes, such as initial volume 414, can be defined as the space(s) that only includes “fluid” points. Put another way, the initial volumes are defined as the space which is farther away from the wall than the user-defined size field.

The system refines the initial volume boundaries to expand the initial volume (308). At this point, initial-volume “fluid” area is relatively far away from the wall. To refine the initial volume boundaries, the system expands the initial volume by moving the initial volume boundaries in a direction that is normal to the surface of the initial volume boundaries at each of a plurality of points on the surface, whether in two dimensions or in three dimensions. In effect, the initial volume is expanded or “inflated” in two or three dimensions so that it approaches the exterior walls surrounding the initial volume. Note that the initial volume boundaries, as they are refined, may “stretch” or otherwise deform to conform to the shape of the initial partial volume, as described herein.

FIG. 5 illustrates an example of expanding initial volumes in a model 500 in accordance with disclosed embodiments. In this example, a first partial volume 502 is connected to gap 506, so that they together form the single enclosed volume. In this example, the first initial volume 514 is shown with the first initial volume boundaries refined from the position shown as first initial volume boundaries 516 to the position shown with a different pattern as first initial volume boundaries 518. Arrows 520 illustrate that the initial volume boundaries are moved a direction that is normal to the surface of the initial volume boundaries at each of a plurality of points on the surface, whether in two dimensions or in three dimensions (shown by necessity, in this example, in two dimensions). While this illustration is only drawn to the first partial volume, a similar process can be performed on the second partial volume.

Moving the initial volume boundaries can be performed by traversing the near-wall areas (the area surrounding the initial volume and between the initial volume and the exterior walls) using a gradient-descent method until, at each point, the refined boundaries meet the exterior wall at the corresponding points or the gradient of the distance to the nearest exterior wall(s) reduces to zero. The gradient will reduce to zero near the gaps, and so terminating the traversal when the gradient reduces to zero prevents the process from expanding the initial volume boundaries into the gap(s). The places where the gradient reduces to zero are candidates for placement of new surfaces which would separate the volumes. Gradient-descent techniques are known to those of skill in the art and are described, at time of filing, for example at en.wikipedia.org/wiki/Gradient_descent.

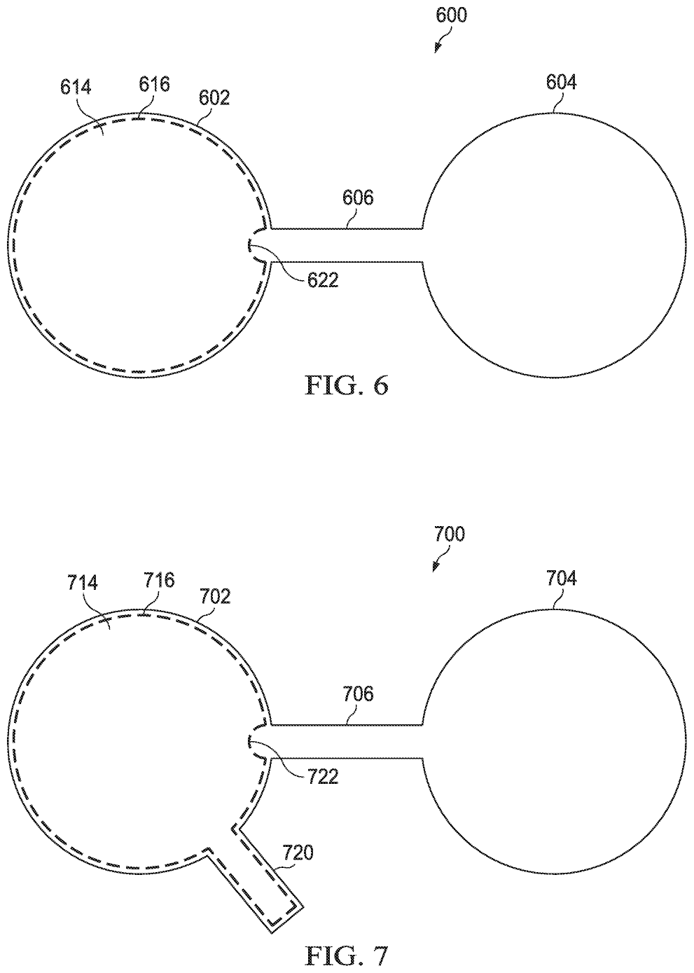

FIG. 6 illustrates an example of the result of expanding the initial volumes in a model 600 in accordance with disclosed embodiments. In this example, a first partial volume 602 is connected to gap 606, so that they together form the single enclosed volume. In this example, the first initial volume 614 is shown with the first initial volume boundaries 616 refined from their original position defined by the wall-distance value to a position where the gradient has reduced to zero using the gradient descent method or where the first initial volume boundaries 616 have met the walls of the first initial volume 614. Note that, in most of the initial first partial volume 602, the refined first initial volume boundaries are now co-extensive with the actual walls of the first partial volume 602. By contrast, note that at the gap 606, the first initial volume boundaries 616 at area 622 are offset from the gap 606. This is because, using the gradient descent method, the gradient has reduced to zero as or before it reaches the gap 606 since expanding in the normal (perpendicular) direction from the initial boundaries no longer reduces the distance to the nearest walls. Note that these figures are not to scale, and the principles described herein apply to any shapes that form the partial volumes and the gaps. As described herein, a similar process can (and typically will be) performed on the second partial volume 604.

In some cases, structures in the volume may produce a zero gradient but still should be included with a volume, because these structures are not a gap between volumes. For ease of reference, such structures are referred to as a “pocket” herein, regardless of specific shape. The system can determine whether a volume portion is topologically adjacent to only one volume (the expanded initial volume) (310) and expand the initial volume boundaries to the walls of this non-gap pocket so that it is included in the expanded initial volume. This process of “absorbing” pockets into the initial volume ensures that the separated volumes below include all contiguous volume space except for the gaps.

FIG. 7 illustrates another example of the result of expanding the initial volumes in a model 700 in accordance with disclosed embodiments, where there is a pocket. In this example, a first partial volume 702 is connected to gap 706, so that they together form the single enclosed volume. The first partial volume 702, in this case, includes a pocket 720. Note that where pocket 720 is only topologically adjacent to the first partial volume 702, and so should be considered a part of first partial volume 702, gap 706 is topologically adjacent to both first partial volume 702 and second partial volume 704 (which because it is, in fact, a gap). In this example, the first initial volume 714 is shown with the first initial volume boundaries 716 refined from their original position defined by the wall-distance value to a position where the gradient has reduced to zero using the gradient descent method or where the first initial volume boundaries 716 have met the walls of the first partial volume 702. Note that, in most of the initial first partial volume 702, the refined first initial volume boundaries are now co-extensive with the actual walls of the first partial volume 702. By contrast, note that at the gap 706, the first initial volume boundaries 716 at area 722 are offset from the gap 706. This is because, using the gradient descent method, the gradient has reduced to zero as or before it reaches the gap 706 since expanding in the normal direction from the initial boundaries no longer reduces the distance to the nearest walls. At pocket 720, however, because it is a pocket and not a gap, the refined first initial volume boundaries 716 fill pocket 720 to its walls. As described herein, a similar process can (and typically will be) performed on the second partial volume 704.

The system generates new surfaces along the initial volume boundaries along the zero-gradient points (310). At this point the initial volume boundaries have been expanded to meet the exterior walls at points other than the gap, so those walls are used as the walls bounding the separated volume. The new surfaces connect points along these walls, along the zero-gradient points, to separate the new separated volume (the expanded initial volume) from the gap volume. The gap volumes are those regions of space which are topologically adjacent to two or more separated volumes and are allowed to persist and keep the volumes separate.

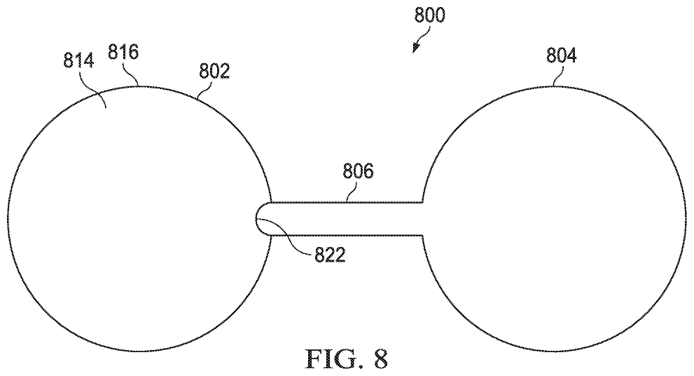

FIG. 8 illustrates an example of a modified model 800 in accordance with disclosed embodiments that includes new surfaces. In this example, the original first partial volume 802 was connected to gap 806, so that they together formed the single enclosed volume. In this example, the first initial volume boundaries (in their refined positions) can be discarded where they have met the walls of the first partial volume 802, leaving the original walls of the first partial volume 802. By contrast, at the gap 806, however, the first initial volume boundaries 616 at area 622 (shown in FIG. 6) are replaced with new surfaces 822. New surfaces 822 are connected to and contiguous with the preserved walls of the first partial volume 802 and separate the original first partial volume 802 from gap 806, forming separate volumes. Of course, as described herein, a similar process can (and typically will be) performed on the second partial volume 804, so that first partial volume 802, second partial volume 804, and gap 806 are all separate volumes in the modified model.

The system stores and/or displays the model including the added surfaces (312). At this point, the modified model including the added surfaces successfully and accurately separate the different volumes from each other and from the gap volume. The system can thereafter manufacture a product based at least in part on the modified model.

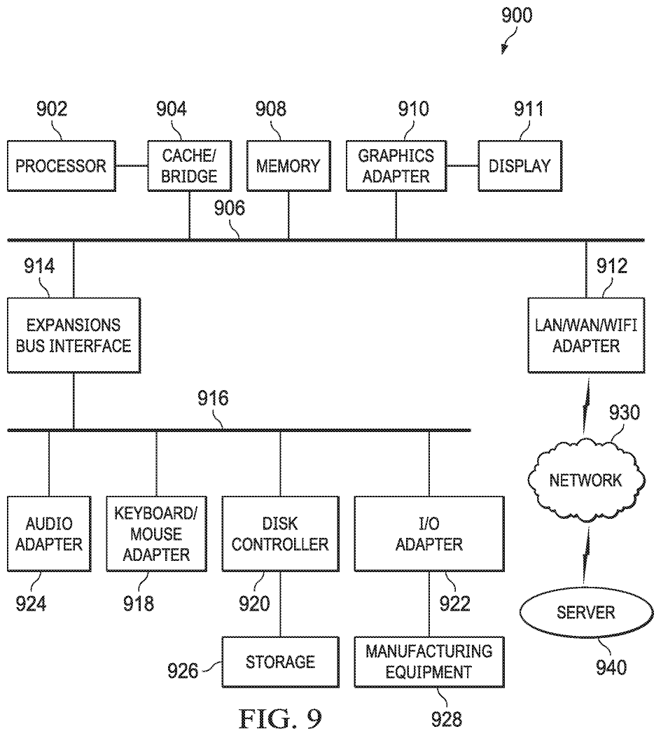

FIG. 9 illustrates a block diagram of a data processing system 900 in which an embodiment can be implemented, for example as a CAD or PDM system particularly configured by software or otherwise to perform the processes as described herein, and in particular as each one of a plurality of interconnected and communicating systems as described herein. The data processing system depicted includes a processor 902 connected to a level two cache/bridge 904, which is connected in turn to a local system bus 906. Local system bus 906 may be, for example, a peripheral component interconnect (PCI) architecture bus. Also connected to local system bus in the depicted example are a main memory 908 and a graphics adapter 910. The graphics adapter 910 may be connected to display 911.

Other peripherals, such as local area network (LAN)/Wide Area Network/Wireless (e.g. Wi-Fi) adapter 912, may also be connected to local system bus 906. Expansion bus interface 914 connects local system bus 906 to input/output (I/O) bus 916. I/O bus 916 is connected to keyboard/mouse adapter 918, disk controller 920, and I/O adapter 922. Disk controller 920 can be connected to a storage 926, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 926 can store any CAD data, models, executable code, variables, or other information or data discussed herein or useful for performing processes as discussed herein.

Also connected to I/O bus 916 in the example shown is audio adapter 924, to which speakers (not shown) may be connected for playing sounds. Keyboard/mouse adapter 918 provides a connection for a pointing device (not shown), such as a mouse, trackball, track pointer, touchscreen, etc. I/O bus 916 can also be connected to manufacturing equipment 928 either directly or via I/O adapter 922 for manufacturing parts according to the processes disclosed herein.

Those of ordinary skill in the art will appreciate that the hardware depicted in FIG. 9 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 912 can be connected to a network 930 (not a part of data processing system 900), which can be any public or private data processing system network or combination of networks, as known to those of skill in the art, including the Internet. Data processing system 900 can communicate over network 930 with server system 940, which is also not part of data processing system 900, but can be implemented, for example, as a separate data processing system 900.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 900 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle.

1. A method comprising:
by a data processing system:
receiving a model of a part to be manufactured, wherein the model includes a first partial volume connected via a gap to a second partial volume;
receiving a wall-distance value;
applying the wall-distance value to the first partial volume of the model to define an initial volume having initial-volume boundaries;
refining the initial-volume boundaries;
generating at least one new surface in the model; and
storing a modified model of the part to be manufactured, including the new surface.

2. The method of claim 1, wherein refining the initial-volume boundaries is performed using a gradient-descent method.

3. The method of claim 1, wherein refining the initial-volume boundaries includes moving the initial volume boundaries in a direction that is normal to a surface of the initial volume boundaries at each of a plurality of points on the surface.

4. The method of claim 1, wherein refining the initial-volume boundaries includes moving the initial volume boundaries in a direction that is normal to a surface of the initial volume boundaries at each of a plurality of points on the surface until the initial volume boundaries meet a wall of the first partial volume or until a gradient of a gradient-descent method reaches zero.

5. The method of claim 1, wherein the first partial volume is a two-dimensional volume or a three-dimensional volume.

6. The method of claim 1, wherein the new surface is created to separate the first partial volume from the gap.

7. The method of claim 1, wherein the new surface is created to separate the first partial volume from the gap where a gradient of a gradient-descent method reaches zero.

8. The method of claim 1, further comprising manufacturing a product based at least in part on the modified model.

9. The method of claim 1, wherein the first partial volume includes a pocket.

10. (canceled)

11. (canceled)

12. A system comprising:
a processor; and
a memory comprising instructions that, when executed by the processor, cause a data processing system to:
receive a model of a part to be manufactured, wherein the model includes a first partial volume connected via a gap to a second partial volume;
receive a wall-distance value;
apply the wall-distance value to the first partial volume of the model to define an initial volume having initial-volume boundaries;
refine the initial-volume boundaries;
generate at least one new surface in the model; and
store a modified model of the part to be manufactured, including the new surface.

13. The system of claim 12, wherein the instructions cause the data processing system to refine the initial-volume boundaries using a gradient-descent method.

14. The system of claim 12, wherein the instructions cause the data processing system to refine the initial-volume boundaries by moving the initial volume boundaries in a direction that is normal to a surface of the initial volume boundaries at each of a plurality of points on the surface.

15. The system of claim 12, wherein the instructions cause the data processing system to refine the initial-volume boundaries by moving the initial volume boundaries in a direction that is normal to a surface of the initial volume boundaries at each of a plurality of points on the surface until the initial volume boundaries meet a wall of the first partial volume or until a gradient of a gradient-descent method reaches zero.

16. The system of claim 12, wherein the new surface is created to separate the first partial volume from the gap.

17. A non-transitory computer-readable medium comprising instructions that, when executed by a processor, cause a system to:
receive a model of a part to be manufactured, wherein the model includes a first partial volume connected via a gap to a second partial volume;
receive a wall-distance value;
apply the wall-distance value to the first partial volume of the model to define an initial volume having initial-volume boundaries;
refine the initial-volume boundaries;
generate at least one new surface in the model; and
store a modified model of the part to be manufactured, including the new surface.

18. The non-transitory computer-readable medium of claim 17, wherein the instructions cause the system to refine the initial-volume boundaries using a gradient-descent method.

19. The non-transitory computer-readable medium of claim 17, wherein the instructions cause the system to refine the initial-volume boundaries by moving the initial volume boundaries in a direction that is normal to a surface of the initial volume boundaries at each of a plurality of points on the surface.

20. The non-transitory computer-readable medium of claim 17, wherein the instructions cause the system to refine the initial-volume boundaries by moving the initial volume boundaries in a direction that is normal to a surface of the initial volume boundaries at each of a plurality of points on the surface until the initial volume boundaries meet a wall of the first partial volume or until a gradient of a gradient-descent method reaches zero.

21. The non-transitory computer-readable medium of claim 17, wherein the new surface is created to separate the first partial volume from the gap.

22. The non-transitory computer-readable medium of claim 17, wherein the new surface is created to separate the first partial volume from the gap where a gradient of a gradient-descent method reaches zero.
